(19) United States
(12) Patent Application Publication
(10) Pub. No.: US 2025/0077062 A1
(43) Pub. Date: Mar. 6, 2025

(54) INTERFACE DISPLAY METHOD, ELECTRONIC DEVICE, AND NON-TRANSITORY COMPUTER-READABLE STORAGE MEDIUM

(71) Applicant: GUANGDONG OPPO MOBILE TELECOMMUNICATIONS CORP., LTD., Dongguan (CN)

(72) Inventors: Boyu MO, Dongguan (CN); Jiabai Wei, Dongguan (CN); Fanxiu Kong, Dongguan (CN)

(73) Assignee: GUANGDONG OPPO MOBILE TELECOMMUNICATIONS CORP., LTD., Dongguan (CN)

(21) Appl. No.: 18/952,365

(22) Filed: Nov. 19, 2024

Related U.S. Application Data
(63) Continuation of application No. PCT/CN2022/143817, filed on Dec. 30, 2022.

(30) Foreign Application Priority Data
May 23, 2022 (CN) 202210564177.9

(51) Int. Cl. G06F 3/04845

(52) U.S. Cl. CPC G06F 3/04845; G06F 2203/04803

(57) ABSTRACT

An interface display method is applicable to an electronic device, and the electronic device includes a display screen. The interface display method includes: displaying a first interface of an application on the display screen; and displaying a first area and a second area, displaying the first interface in the first area, and displaying a second interface of the application jumped from the first interface in the second area, in response to detecting a preset operation and detecting an interface jump operation for the first interface, during the process of displaying the first interface, where both of the first area and the second area are configured to display an interface of the application. An electronic device, and a non-transitory computer-readable storage medium are further provided.

### CROSS REFERENCE TO RELATED APPLICATIONS

The present disclosure is a continuation-application of International (PCT) Patent Application No. PCT/CN2022/143817, filed Dec. 30, 2022, which claims foreign priority of China Patent Applicant No. 202210564177.9, filed on May 23, 2022, the entire contents of both of which are hereby incorporated by reference in their entirety.

### TECHNICAL FIELD

The present disclosure relates to the field of human-computer interaction technologies, and in particular to an interface display method, an electronic device, and a non-transitory computer-readable storage medium.

### BACKGROUND

With the development of computer technologies, an application has become more and more common in people's daily lives. An interface is an important part of the application. The interface may provide information to a user, and may allow the user to interact with the application.

### SUMMARY OF THE PRESENT DISCLOSURE

According to a first aspect, some embodiments of the present disclosure provide an interface display method. The method is applicable to an electronic device, and the electronic device includes a display screen. The method includes: displaying a first interface of an application on the display screen; and displaying a first area and a second area, displaying the first interface in the first area, and displaying a second interface of the application jumped from the first interface in the second area, in response to detecting a preset operation and detecting an interface jump operation for the first interface, during the process of displaying the first interface, where both of the first area and the second area are configured to display an interface of the application.

According to a second aspect, some embodiments of the present disclosure further provide an electronic device. The electronic device includes a memory and a processor, the memory stores a computer program, and the processor execute the computer program to perform the interface display method described in the first aspect.

According to a third aspect, some embodiments of the present disclosure further provide a non-transitory computer-readable storage medium. A computer program is stored on the non-transitory computer-readable storage medium, and the computer program is configured to be executed by a processor to perform the interface display method described in the first aspect.

### BRIEF DESCRIPTION OF THE DRAWINGS

FIG. 1 is a flowchart of an interface display method according to an embodiment of the present disclosure.

FIG. 2 is a schematic diagram of displaying an interface according to an embodiment of the present disclosure.

FIG. 3 is a schematic diagram of displaying an interface according to an embodiment of the present disclosure.

FIG. 4 is a schematic diagram of displaying an interface according to an embodiment of the present disclosure.

FIG. 5 is a schematic diagram of displaying an interface according to an embodiment of the present disclosure.

FIG. 6 is a schematic diagram of displaying an interface according to an embodiment of the present disclosure.

FIG. 7 is a schematic diagram of displaying an interface according to an embodiment of the present disclosure.

FIG. 8 is a schematic diagram of displaying an interface according to an embodiment of the present disclosure.

FIG. 9 is a schematic diagram of displaying an interface according to an embodiment of the present disclosure.

FIG. 10 is a schematic diagram of displaying an interface according to an embodiment of the present disclosure.

FIG. 11 is a schematic diagram of displaying an interface according to an embodiment of the present disclosure.

FIG. 12 is a schematic diagram of displaying an interface according to an embodiment of the present disclosure.

FIG. 13 is a schematic diagram of displaying an interface according to an embodiment of the present disclosure.

FIG. 14 is a schematic diagram of displaying an interface according to an embodiment of the present disclosure.

FIG. 15 is a schematic diagram of displaying an interface according to an embodiment of the present disclosure.

FIG. 16 is a schematic diagram of displaying an interface according to an embodiment of the present disclosure.

FIG. 17 is a schematic diagram of displaying an interface according to an embodiment of the present disclosure.

FIG. 18 is a schematic diagram of displaying an interface according to an embodiment of the present disclosure.

FIG. 19 is a schematic diagram of displaying an interface according to an embodiment of the present disclosure.

FIG. 20 is a schematic diagram of displaying an interface according to an embodiment of the present disclosure.

FIG. 21 is a flowchart of an interface display method according to an embodiment of the present disclosure.

FIG. 22 is a schematic diagram of a technical implementation mode of the interface display method according to an embodiment of the present disclosure.

FIG. 23 is a structural block diagram of an interface display apparatus according to an embodiment of the present disclosure.

FIG. 24 is a schematic diagram of an internal structure of an electronic device according to an embodiment of the present disclosure.

### DETAILED DESCRIPTION

In order to make the purpose, technical solutions and advantages of the present disclosure clearer and more understandable, the application is described in further detail below by referring to the accompanying drawings and embodiments. It shall be understood that specific embodiments described herein are intended to explain the present disclosure only and are not intended to limit the present disclosure.

In order to improve the flexibility of interface display, an interface display method may be provided by some embodiments of the present disclosure. The interface display method may be implemented by an interface display apparatus. The interface display apparatus may be implemented as part or all of an electronic device through software, hardware, or a combination thereof. In the following embodiments, the method being implemented by an electronic device may be taken as an example for description. The electronic device includes a display screen. The electronic device may be, but not limited to, various personal computers, laptops, smart phones, tablets, Internet of Things devices, and portable wearable devices. The Internet of Things devices may be smart speakers, smart TVs, smart tuners, smart car device, etc. The portable wearable devices may be smart watches, smart bracelets, head-mounted devices, etc.

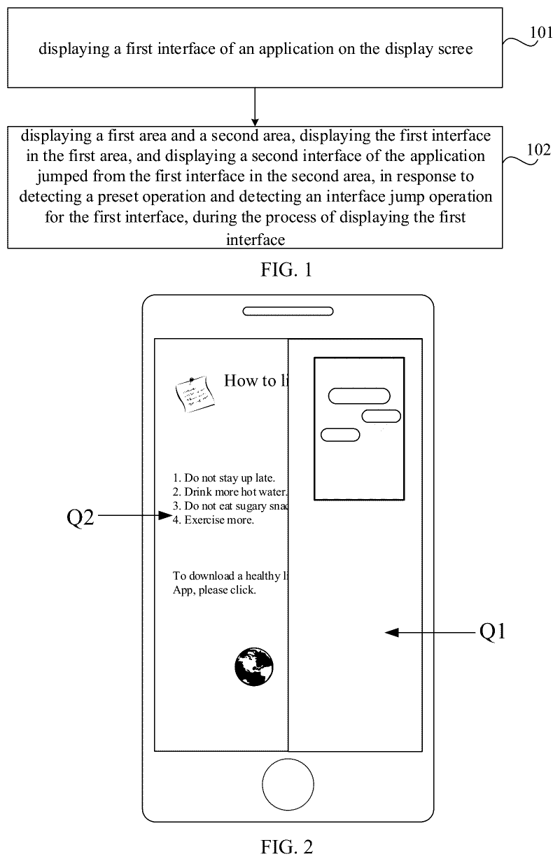

In an embodiment, as shown in FIG. 1, an interface display method may be provided by the present disclosure. The method applicable to an electronic device may be taken as an example for description, and the method may include the following operations.

In an operation 101, a first interface of an application is displayed on a display screen.

The application may be a system application, or a third-party application. The application may be a video application, an instant messaging application, a news application, music application, a game application, or the like. In the embodiments of the present disclosure, a specific type of the application is not limited herein.

In an operation 102, in response to detecting a preset operation and detecting an interface jump operation for the first interface, the first area and the second area are displayed, the first interface is displayed in the first area, and a second interface of the application jumped from the first interface is displayed in the second area, during the process of displaying the first interface.

Both of the first area and the second area are configured to display an interface of the application.

In some embodiments of the present disclosure, the preset operation may include at least one of: a target gesture operation, a drag-and-drop operation for a drag-and-drop control, and a triggering operation for a fixed control.

In some embodiments of the present disclosure, the second area may be configured to display a main interface where the user may currently interact with the electronic device. The first area may be configured to display a scaled-down/reduced interface, for example, the first area may be configured to display a scaled-down first interface. In addition, it should be noted that the scaled-down first interface in the first area is a keep-alive interface, that is, a real-time change of interface content may be reflected through the scaled-down first interface in the first area.

In some embodiments, the first area may be superimposed on the second area and may cover a part of the second area.

As shown in FIG. 2, a second area Q2 covers an entire display screen. A first area Q1 is superimposed on the second area Q2. Further, the first area Q1 may also cover a right area of the second area Q2. It should be noted that as illustrated in FIG. 2, the first area Q1 covers the right area of the second area Q2. However, in some practical embodiments, the first area Q1 may also cover a left area, a top area, or a bottom area of the second area Q2. In the embodiments of the present disclosure, a way in which the second area Q2 is covered by the first area Q1 is not limited herein.

It should be noted that in a displaying manner that the first area is superimposed on the second area and covers the part of the second area, the first area may be called to superimpose on the second area. Alternatively, the first area may be hidden, such that the second area may be displayed in full screen on the display screen of the electronic device. In the embodiments of the present disclosure, a way to call or hide the first area is not limited herein.

In other embodiments, there is no overlapping area between the first area and the second area, that is, the first area and the second area are not overlapped with each other.

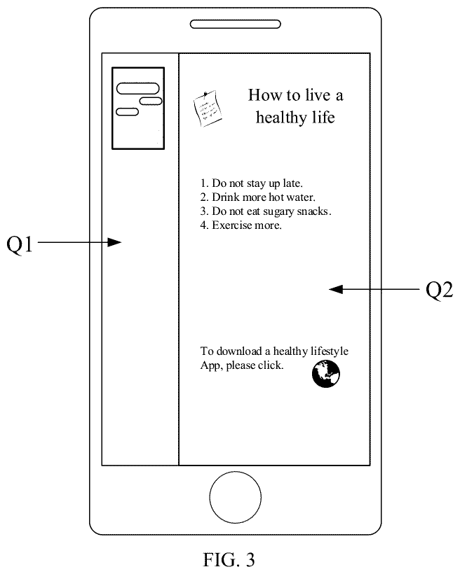

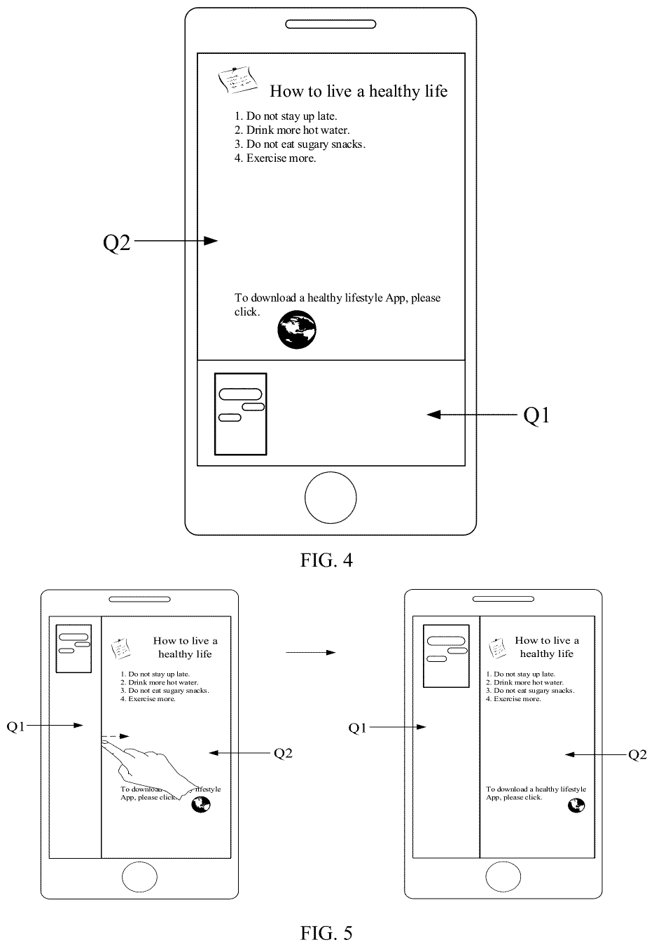

As shown in FIG. 3, the first area Q1 is located in a left area of the display screen, the second area Q2 is located in a right area of the display screen, and there is no overlapping area between the first area Q1 and the second area Q2. It should be noted that as illustrated in FIG. 3, in an embodiment, the first area Q1 is located in the left area of the display screen, and the second area Q2 is located in the right area of the display screen. In some practical embodiments, the first area Q1 may be located in the right area of the display screen, and the second area Q2 may be located in the left area of the display screen. Alternatively, the first area Q1 may be located in a top area of the display screen, and the second area Q2 may be located in a bottom area of the display screen. Alternatively, the first area Q1 may be located in the bottom area of the display screen, and the second area Q2 may be located in the top area of the display screen. In other words, in some practical embodiments, the first area Q1 and the second area Q2 may be horizontally arranged or arranged longitudinally. As illustrated in FIG. 4, the first area Q1 and the second area Q2 are arranged longitudinally. As illustrated in FIG. 4, the first area Q1 is located in the bottom area of the display screen, and the second area Q2 is located in the top area of the display screen.

In a condition where there is overlapping area between the first area and the second area, a size of the first area may be equal to or unequal to a size of the second area. In some embodiments, the size of the first area may be smaller than the size of the second area.

It should be noted that, in some embodiments of the present disclosure, in a condition of a size of the display screen of the electronic device being smaller than a preset size threshold, the first area and the second area may be displayed in a displaying manner that the first area is superimposed on the second area and covers the part of the second area. In condition of a size of the display screen of the electronic device being greater than or equal to a preset size threshold, the first area and the second area may be displayed in a displaying manner that the first area and the second area are non-overlapping.

In some embodiments, in response to a size adjusting operation triggered by the user, the electronic device may adjust at least one of the size of the first area and the size of the second area. The size adjusting operation may be a dragging operation for a dividing line between the first area and the second area. Alternatively, the size adjusting operation may be a dragging operation for a boundary line of the first area. Alternatively, the size adjusting operation may be a dragging operation for a boundary line of the second area. In the embodiments of the present disclosure, a specific type of the size adjusting operation is not limited herein.

As shown in FIG. 5, in a condition where there is overlapping area between the first area and the second area, the user may drag a dividing line between the first area Q1 and the second area Q2. In response to the electronic device detecting the dragging operation, the size of the first area Q1 and the size of the second area Q2 may be adjusted based on the dragging operation. As shown in FIG. 5, after the size adjusting operation is performed, the size of the first area Q1 is increased, and at the same time, the size of the second area Q2 is decreased.

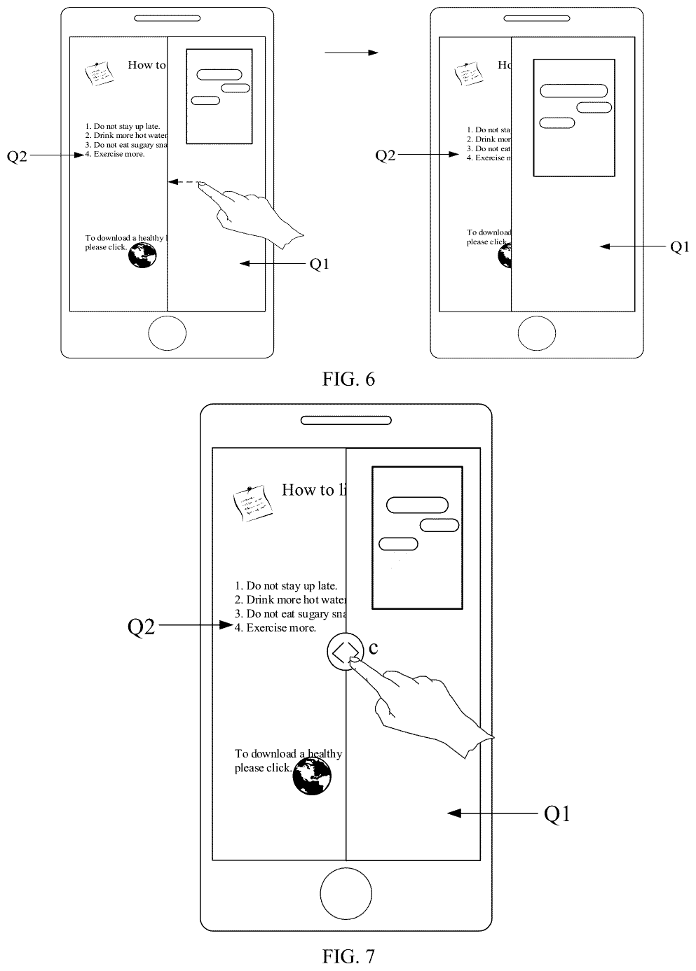

As shown in FIG. 6, in a condition of the first area being superimposed on the second area, the user may drag a boundary line of the first area Q1. In response to the electronic device detecting the dragging operation, the size of the first area Q1 may be adjusted based on the dragging operation. As shown in FIG. 6, after the size adjusting operation is performed, the size of the first area Q1 is increased.

It should be noted that the above-mentioned size adjusting shown in FIG. 5 and FIG. 6 is merely an exemplary embodiment. In some practical embodiments, the first area Q1 may be superimposed on the second area Q2, and the first area may cover the left area, the top area, or the bottom area of the second area Q2. Alternatively, there is no overlapping area between the first area Q1 and the second area Q2, and the first area Q1 and the second area Q2 are disposed in one of following ways: the first area Q1 is located in the right area of the display screen and the second area Q2 is located in the left area of the display screen, the first area Q1 is located in the top area of the display screen and the second area Q2 is located in the bottom area of the display screen, and the first area Q1 is located in the bottom area of the display screen and the second area Q2 is located in the top area of the display screen. A way to adjust the size on the electronic device is the same as that shown in FIG. 5 and FIG. 6, which will not be repeated herein.

In some embodiments, the first area may include a drawer control. In this case, during the process of displaying the first area, other parts in the first area except the drawer control may be hidden in response to detecting a triggering operation for the drawer control.

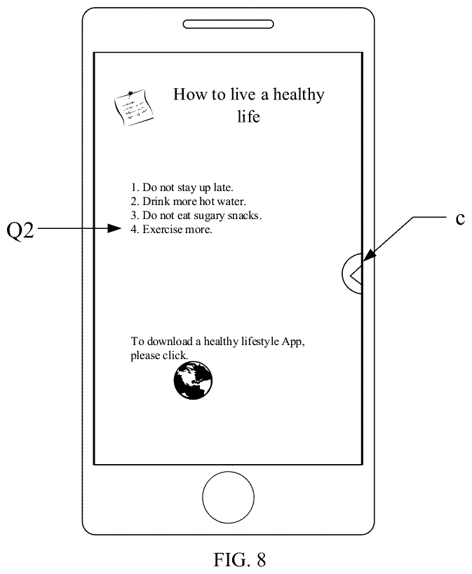

As shown in FIG. 7, the second area Q2 covers the entire display screen, and the first area Q1 is superimposed on the second area Q2 and covers the right area of the second area Q2. The first area Q1 includes a drawer control c, and the drawer control c may be located in a left boundary line of the first area Q1. In response to the electronic device detecting a triggering operation for the drawer control c, other parts in the first area Q1 except the drawer control c may be hidden. As shown in FIG. 8, the other parts in the first area Q1 except the drawer control c is hidden after the drawer control c is triggered. As shown in FIG. 8, after the first area Q1 is hidden, the second area Q2 may be displayed in full screen on the electronic device without any obstruction.

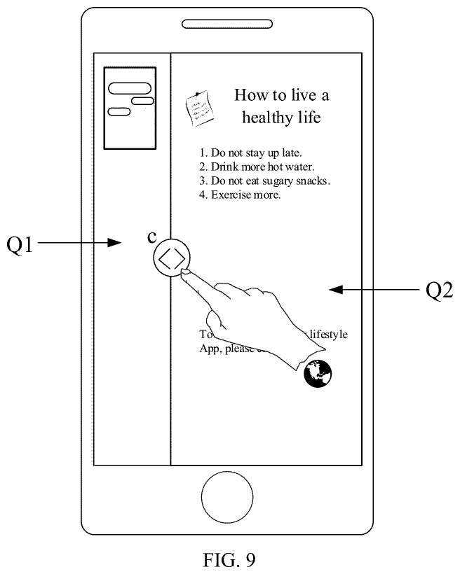

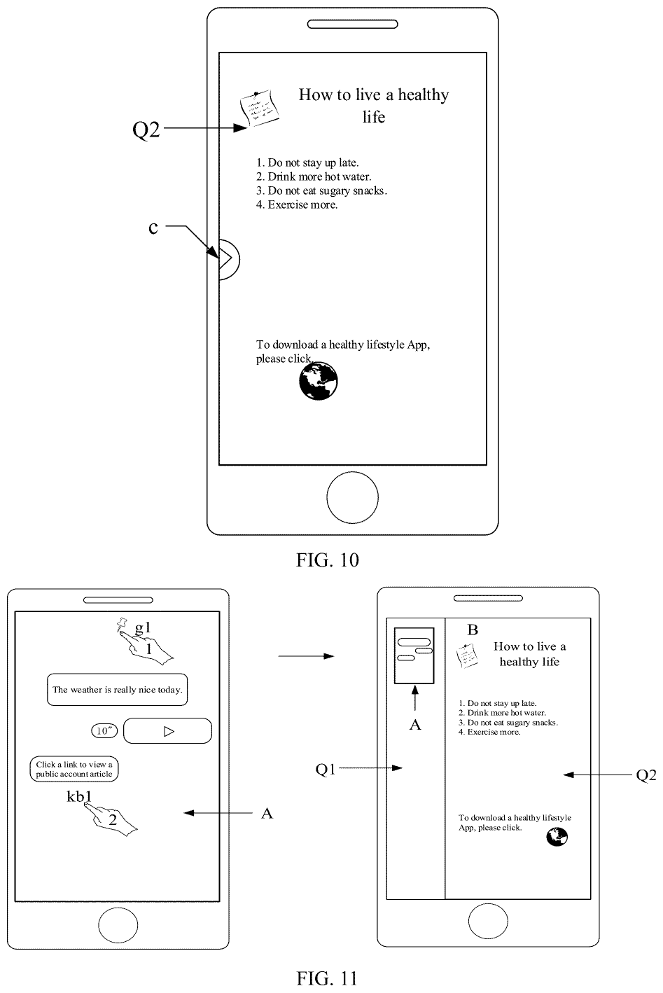

As shown in FIG. 9, the first area Q1 is located in the left area of the display screen, and the second area Q2 is located in the right area of the display screen. There is no overlapping area between the first area Q1 and the second area Q2. The first area Q1 includes a drawer control c, and the drawer control c may be located in a right boundary line of the first area Q1. In response to the electronic device detecting a triggering operation for the drawer control c, other parts in the first area Q1 except the drawer control c may be hidden. As shown in FIG. 10, the other parts in the first area Q1 except the drawer control c is hidden after the drawer control c is triggered. As shown in FIG. 10, after the first area Q1 is hidden, the electronic device automatically enlarges the second area Q2, and an enlarged second area Q2 covers the entire display screen. The second area Q2 may be displayed in full screen on the electronic device without any obstruction.

It should be noted that in some practical embodiments, after the drawer control c is triggered, a part of the drawer control c may be hidden, and the other part of the drawer control c is not be hidden.

In some embodiments of the present disclosure, after the other parts in the first area except the drawer control is hidden, the first area may be redisplayed by the electronic device in response to detecting the triggering operation for the drawer control. As illustrated in FIG. 7 and FIG. 9, the first area is redisplayed by the electronic device, which will not be repeated herein.

It should be noted that the above-mentioned operation for the drawer control shown in FIGS. 7-10 is merely an exemplary embodiment. In some practical embodiments, the first area Q1 may be superimposed on the second area Q2, and the first area Q1 may cover the left area, the top area, or the bottom area of the second area Q2. Alternatively, there is no overlapping area between the first area Q1 and the second area Q2, and the first area Q1 and the second area Q2 are disposed in one of the following ways: the first area Q1 is located in the right area of the display screen and the second area Q2 is located in the left area of the display screen, the first area Q1 is located in the top area of the display screen and the second area Q2 is located in the bottom area of the display screen, and the first area Q1 is located in the bottom area of the display screen and the second area Q2 is located in the top area of the display screen. An operation way of the drawer control is also the same as that shown in FIGS. 7-10, which will not be repeated herein.

According to the above description, a main purpose of arranging the drawer control is to hide the first area when necessary, so as to ensure that the second area may be displayed in full screen clearly and without blocking. In some embodiments, the requirement can only be met when the size of the display screen of the electronic device is small, while when the size of the display screen of the electronic device is large, the first area and the second area may be fixedly displayed on the display screen of the electronic device.

Based on the above consideration, in some embodiments of the present disclosure, the electronic device may display the drawer control in the first area when the size of the display screen is less than the preset size threshold. The electronic device may not display the drawer control in the first area when the size of the display screen is not less than the preset size threshold.

In addition, in the displaying manner in which the first area is superimposed on the second area and covers the part of the second area, the electronic device may fixedly display the drawer control in the first area without considering the size of the display screen of the electronic device.

In some embodiments, at least one of the first area and the second area may include a closing control. In this case, in response to detecting a triggering operation for the closing control, the first area or the second area may be closed based on an area set by the triggered closing control.

In some embodiments, assuming that the closing control is located/provided in the first area, the first area may be closed after the triggering operation for the closing control is detected. In other embodiments, assuming that the closing control is located in the second area, the second area may be closed after the triggering operation for the closing control is detected.

In an operation 102, in some embodiments, the first interface may include a first fixed control. In this case, in response to detecting a triggering operation (i.e., the preset operation) for the first fixed control and detecting an interface jump operation that is configured to jump from the first interface to the second interface, the first area and the second area are displayed, the first interface is displayed in the first area, and the second interface is displayed in the second area.

It should be noted that the first fixed control may be located/provided in a top area of the first interface to reduce a touch by mistake.

As shown in FIG. 11, the first interface A includes a first fixed control g1. The first fixed control g1 may be located in a top area of the first interface A. In response to detecting a triggering operation for the first fixed control g1, a triggering operation for a control kb1 located in the first interface A is detected subsequently. The interface jump may be triggered by the triggering operation for the control kb1, that is, the second interface of the application is jumped from the first interface, and at this time, the first area Q1 and the second area Q2 may be displayed. A scaled-down first interface A is displayed in the first area Q1, and the second interface B is displayed in the second area Q2.

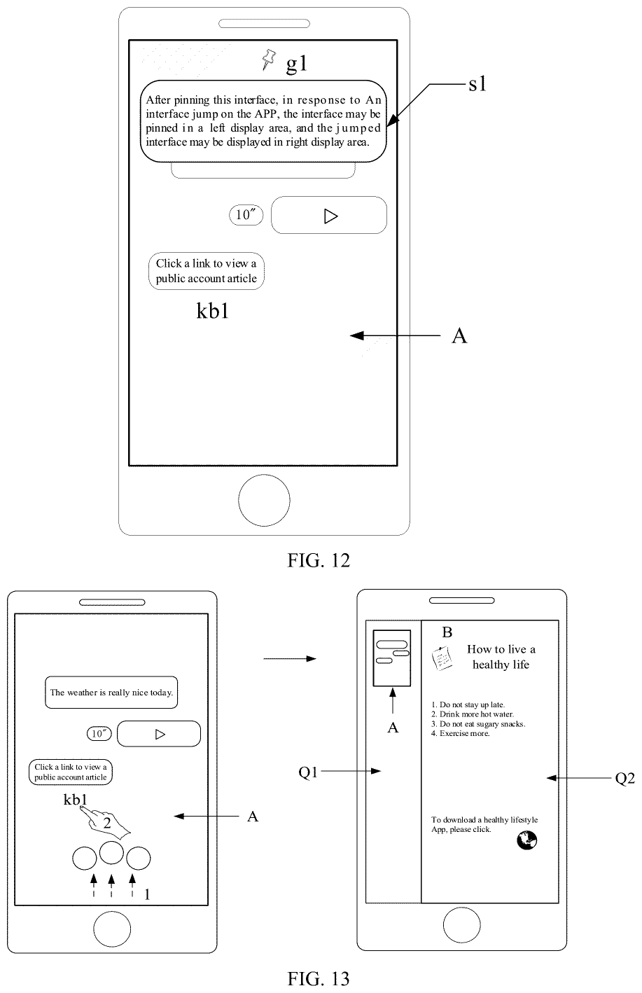

In some embodiments of the present disclosure, in response to the fixed control being displayed for the first time, a first function description interface may be displayed. For example, the first function description interface is superimposed on the first interface, and the first function description interface includes function description information of the fixed control. As shown in FIG. 12, a first function description interface s1 is superimposed on the first interface A.

In operation 102, in some embodiments, in response to detecting a target gesture operation (i.e., the preset operation) for the first interface and the interface jump operation that is configured to jump from the first interface to the second interface, the first area and the second area are displayed, the first interface is displayed in the first area, and the second interface is displayed in the second area. It should be noted that in the embodiments of the present disclosure, the target gesture operation may be an operation of swiping upward simultaneously with three fingers, and a specific type of the target gesture operation is not limited in the embodiments of the present disclosure.

As shown in FIG. 13, in response to detecting the operation of swiping upward simultaneously with three fingers (i.e., three circles as shown in FIG. 13) for the first interface A, the triggering operation for the control kb1 located in the first interface A is detected subsequently. The interface jump may be triggered by the triggering operation for the control kb1, that is, the second interface of the application is jumped from the first interface, and at this time, the first area Q1 and the second area Q2 may be displayed. The scaled-down first interface A is displayed in the first area Q1, and the second interface B is displayed in the second area Q2.

In the interface display method provided by the embodiments of the present disclosure, during the process of displaying the first interface of the application, in response to detecting the preset operation and the interface jump operation for the first interface, the first area and the second area are displayed, the first interface is displayed in the first area, and the second interface of the application jumped from the first interface is displayed in the second area. Both the first area and the second area are configured to display the interface of the application, such that two areas may be displayed after the preset operation and the interface jump operation are detected, the first interface may be displayed in at least one of the two areas, and the second interface jumped from the first interface may be displayed in the other of the two areas. In addition, the two areas may be configured to display the interface of the application. Therefore, the effect of simultaneously displaying a plurality of interfaces of the application may be achieved in this way, and thus the flexibility of interface display may be improved.

In the embodiments of the present disclosure, the interface displayed in the first area may be transferred to the second area for display, and the interface displayed in the second area may also be transferred to the first area for display. That is, a position where the interface is displayed may be switched between the first area and the second area.

In the embodiments of the present disclosure, a case that the first area does not include the drawer control may be taken as an example to describe an implementation manner of transferring the interface displayed in the second area to the first area for display as follows.

In an embodiment, in response to detecting the preset operation for a second target interface displayed in the second area and detecting an interface jump operation that is configured to jump from the second interface to a third interface of the application, the second target interface is displayed in the first area, and the third interface is displayed in the second area.

In some embodiments, the second target interface includes a second fixed control. In this case, in response to detecting a triggering operation (i.e., the preset operation) for the second fixed control and detecting an interface jump operation that is configured to jump from the second interface to the third interface of the application, a scaled-down second target interface is displayed in the first area, and the third interface may be displayed in the second area.

Similarly, the second fixed control may be located in the top area of the second target interface to reduce the touch by mistake.

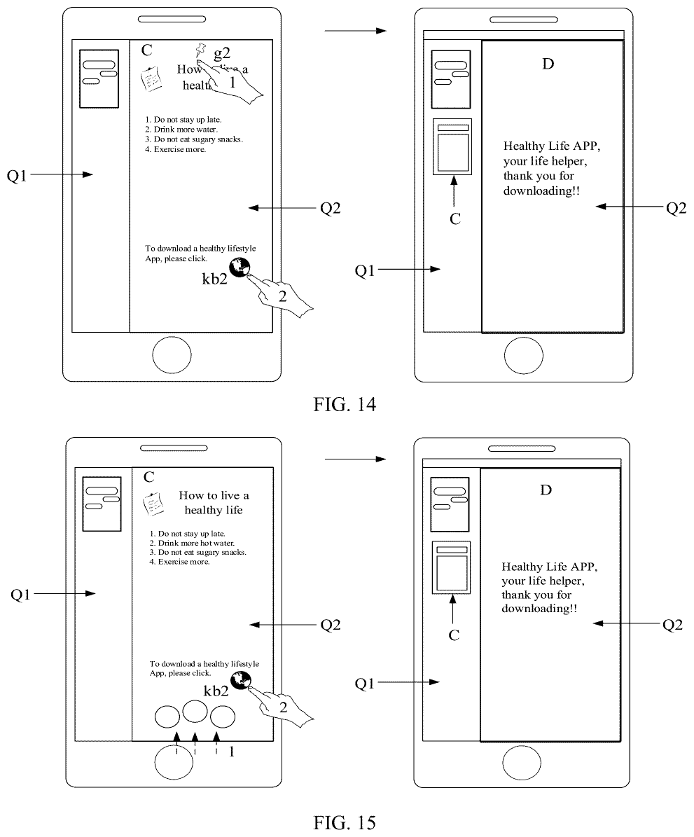

As shown in FIG. 14, a second target interface C (exemplarily, the second target interface C is the same as the second interface as described above) includes a second fixed control g2. The second fixed control g2 may be located in a top area of the second target interface C. In response to detecting a triggering operation for the second fixed control g2, a triggering operation for the control kb2 located in the second target interface C is detected subsequently. The interface jump may be triggered by the triggering operation for the control kb2, that is, a third target interface D of the application is jumped from the second target interface C, and at this time, a scaled-down second target interface C may be displayed in the first area Q1, and the third interface D may be displayed in the second area Q2 at the same time.

It should be noted that in a condition where there is the interface currently displayed in the first area Q1, the second target interface C may be displayed under the interface currently displayed in the first area Q1 (as shown in FIG. 14). In other words, in the embodiments of the present disclosure, a plurality of interfaces may be displayed simultaneously in the first area Q1.

In some embodiments, in response to detecting a target gesture operation (i.e., the preset operation) for the second target interface and detecting an interface jump operation that is configured to jump from the second interface to the third interface of the application, the scaled-down second target interface is displayed in the first area, and the third interface is displayed in the second area.

As shown in FIG. 15, in response to detecting the operation of swiping upward simultaneously with three fingers (i.e., three circles as shown in FIG. 15) for the second target interface C (exemplarily, the second target interface C is the same as the second interface as described above), the triggering operation for the control kb2 located in the second target interface C is detected subsequently. The interface jump may be triggered by the triggering operation for the control kb2, that is, a third target interface D of the application is jumped from the second target interface C, and at this time, a scaled-down second target interface C may be displayed in the first area Q1, and the third interface D may be displayed in the second area Q2 at the same time.

It should be noted that in a condition where there is the interface currently displayed in the first area Q1, the second target interface C may be displayed under the interface currently displayed in the first area Q1.

A case that the first area includes the drawer control is similar to the above description. In some embodiments, in a condition of the first area including the drawer control, in response to detecting the triggering operation for the drawer control, other parts in the first area except the drawer control may be hidden by the electronic device. At this time, in response to detecting the preset operation for the second target interface displayed in the second area and the interface jump operation that is configured to jump from the second interface to the third interface of the application, the second target interface may be placed in a hidden first area by the electronic device, and the third interface may be displayed in the second area.

Similarly, the preset operation herein may be the triggering operation for the second fixed control g2, or may be the operation of swiping upward simultaneously with three fingers.

After the second target interface is placed in the hidden first area, the first area may be redisplayed by the electronic device in response to detecting the triggering operation for the drawer control. At this time, the second target interface may be displayed in the first area.

In the embodiments of the present disclosure, an implementation manner of transferring the interface displayed in the first area to the second area for display may be described as follows. It should be noted that in a condition of the first area including the drawer control, the electronic device may transfer the interface displayed in the first area to the second area for display in a condition where the first area is not hidden.

In some embodiments, in response to detecting the triggering operation for the first target interface displayed in the first area, the second target interface displayed in the second area is replaced by the first target interface.

It should be noted that, as described above, the plurality of interfaces may be displayed simultaneously in the first area. In this case, the first target interface may be one of the plurality of interfaces displayed simultaneously in the first area. In some embodiments, the first target interface may be the above-described first interface, and the second target interface may be the above-described second interface or the above-described third interface.

In an embodiment, in response to replacing the second target interface displayed in the second area with the first target interface, the second target interface may also be displayed in the first area. Of course, in some embodiments, the second target interface may also be displayed in the first area. It should be noted that in a condition where there is the interface currently displayed in the first area, the second target interface may be displayed under the interface currently displayed in the first area.

In some embodiments, before detecting the triggering operation for the first target interface displayed in the first area and in response to detecting the preset operation for the second target interface displayed in the second area, the second target interface is displayed in the first area in a condition of the second target interface displayed in the second area being replaced by the first target interface.

In some embodiments, as described above, the second fixed control may be located/provided in the second target interface. Before the triggering operation for the first target interface is detected, the second target interface may be displayed in the first area in response to detecting the triggering operation (i.e., the preset operation) for the second fixed control in the second target interface.

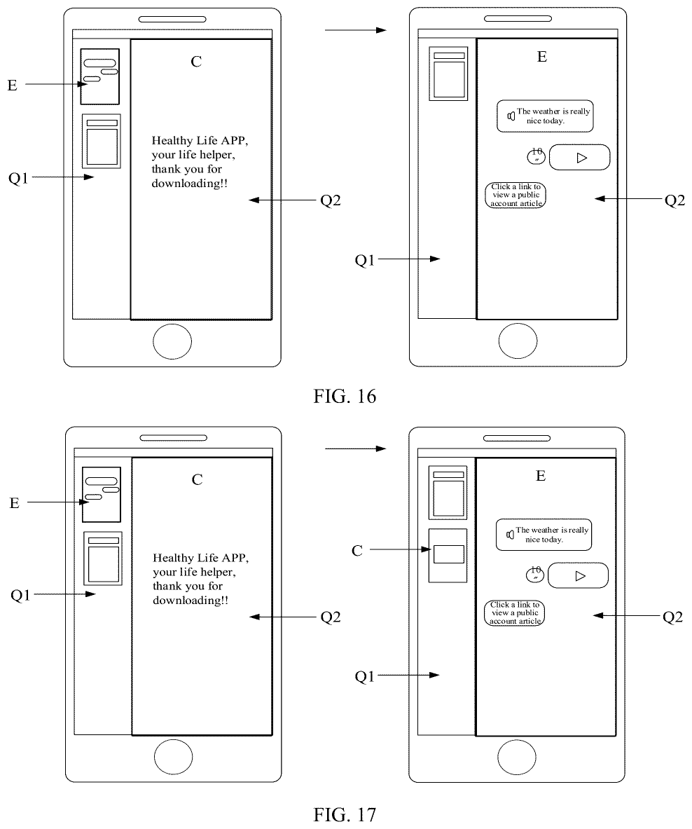

As shown in FIG. 16 and FIG. 17, FIG. 16 and FIG. 17 are two optional schematic diagrams of replacing the second target interface C displayed in the second area Q2 with a first target interface E. A scenario as shown in FIG. 16 may be one where the second fixed control is located/provided in the second target interface C, i.e., the triggering operation (i.e., the preset operation) for the second fixed control in the second target interface C is not detected before the triggering operation for the first target interface E is detected. In this case, after the triggering operation for the first target interface E is detected, the second target interface C displayed in the second area Q2 is directly replaced with the first target interface E. A scenario as shown in FIG. 17 may be one where the second fixed control is located in the second target interface C, i.e., the triggering operation (i.e., the preset operation) for the second fixed control in the second target interface C is detected before the triggering operation for the first target interface E is detected. In this case, after the triggering operation for the first target interface E is detected, the second target interface C displayed in the second area Q2 may switched to the first target interface E, and the scaled-down second target interface C may be displayed in the first area Q1. Exemplarily, a case where the second target interface C is the same as the above-described third interface and the first target interface E is the same as the above-described first interface is only taken as an example.

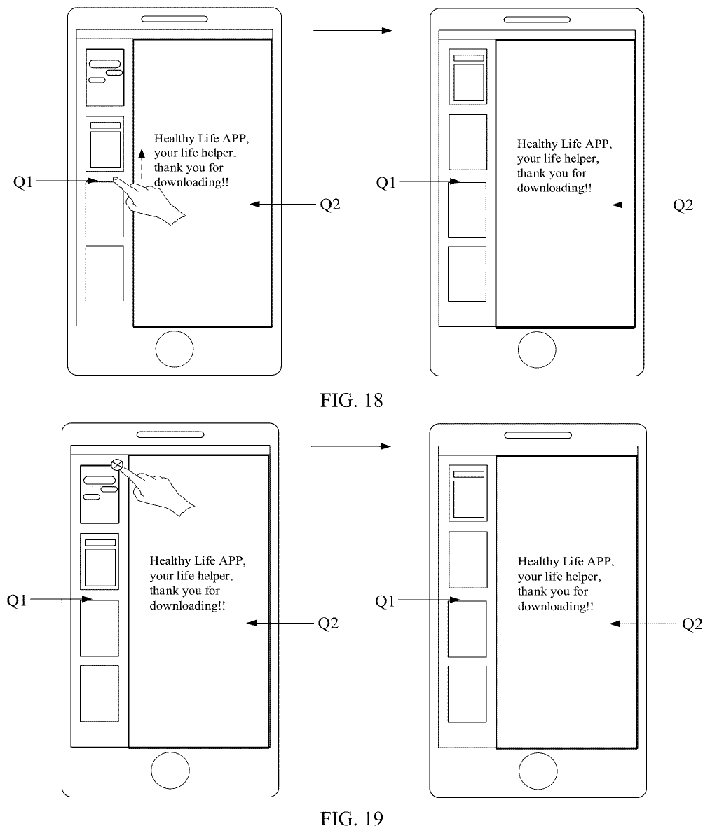

As described above, the first area may be configured to display a plurality of interfaces of the application. In a condition of the first area having a plurality of interfaces therein, in response to detecting a browsing operation (for example, the browsing operation may be a swiping up operation or a swiping down operation) for the first area, the plurality of interfaces in the first area may be swiped on the electronic device in response to the browsing operation. As shown in FIG. 18, the electronic device may swipe the plurality of interfaces in the first area may be swiped on the electronic device in response to the browsing operation.

In addition, in some embodiments, the closing control may further be located/provided in the interface in the first area. In response to detecting a triggering operation for the closing control of the first target interface displayed in the first area, the first target interface may be closed in the first area by the electronic device. As shown in FIG. 19, after the closing control of a first target interface C (exemplarily, the first target interface C is the same as the first interface as described above) displayed in the first area Q1 is triggered, the first target interface C is closed in the first area Q1.

In order to facilitate understanding the technical solutions provided by some embodiments of the present disclosure, an optional interface operation process may be provided in the embodiments of the present disclosure as follows.

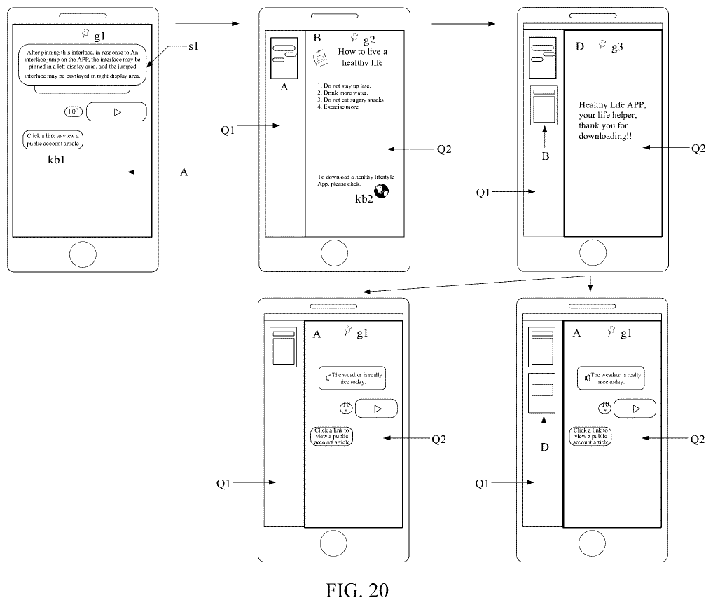

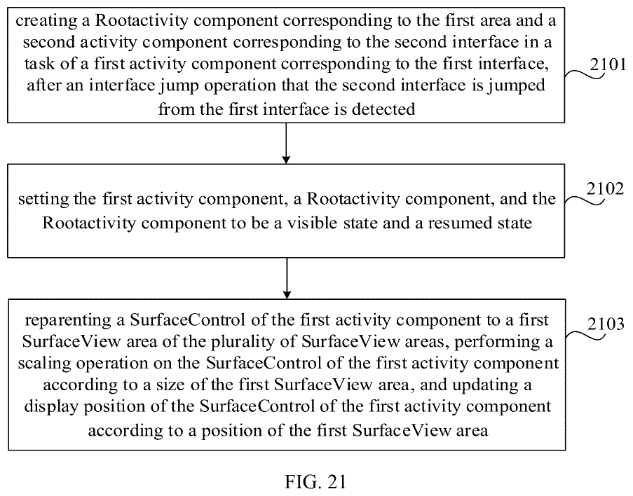

As shown in FIG. 20, a fixed control g1 is located in a top area of the first interface A. In a condition of the fixed control g1 being displayed for the first time, the first function description interface s1 is superimposed on the first interface A. The first function description interface s1 may include function description information of the fixed control g1.

During the process of displaying the first interface A, the user may trigger the fixed control g1 to pin the first interface A. After the first interface A is pinned, the user may perform an interface jump operation (such as a triggering operation for the control kb1 as shown in FIG. 20) for the first interface A to jump to the second interface B. At this time, the first area Q1 and the second area Q2 may be displayed on the display screen of the electronic device. The first interface A is displayed in a thumbnail manner in the first area Q1, the first interface A is displayed in the first area Q1 in a keep-alive manner, and the second interface B is displayed in the second area Q2.

A fixed control g2 is located in a top area of the second interface B. During the process of displaying the second interface B, the user may trigger the fixed control g2 to pin the second interface B. After the second interface B is pinned, the user may perform an interface jump operation (such as a triggering operation for the control kb2 as shown in FIG. 20) for the second interface B to jump to the third interface D. At this time, the second interface B is displayed in a thumbnail manner in the first area Q1, and the second interface B is located under the first interface A, the second interface B is displayed in the first area Q1 in a keep-alive manner, and the third interface D is displayed in the second area Q2.

In a condition where the user wants to redisplay the first interface A in the second area Q2, and the user wants to display the third interface D in the first area Q1, a fixed control g3 in the third interface D may be triggered by the user, and then the first interface A displayed in the first area Q1 may further be triggered by the user. At this time, the third interface D displayed in the second area Q2 is replaced by the first interface A, and the third interface D is displayed under the second interface B in the first area Q1.

In a condition where the user wants to redisplay the first interface A in the second area Q2, and the user does not want to display the third interface D in the first area Q1, the first interface A displayed in the first area Q1 may be directly triggered by the user. At this time, t the third interface D displayed in the second area Q2 is replaced by the first interface A, and the third interface D is directly replaced and is not be displayed in the first area Q1.

During the whole process, in a condition where the user wants to adjust a size of the first area Q1 and a size of the second area Q2, the user may directly drag a dividing line between the first area Q1 and the second area Q2, and the electronic device may adjust the size of the first area Q1 and the size of the second area Q2 in response to the user's dragging operation.

According to the above description, in the embodiment, in response to detecting a preset operation (i.e., the pinned interface as described above) for a certain interface, the electronic device may display a scaled-down interface of the certain interface in an alive manner in the first area Q1 and display the interface jumped from the first interface in the second area, after an interface jump operation for the certain interface is also detected subsequently. In response to detecting the triggering operation for a certain interface displayed in the first area Q1, the electronic device may switch the triggered certain interface to the second area Q2 for display. It may be understood that since an area of the second area Q2 may be greater than an area of the first area Q1, it is more convenient for the user to view information on a corresponding interface in response to the interface triggered in the first area Q1 being switched to be displayed in the second area Q2.

A usage scenario may be taken as an example for description below.

In some embodiments, an instant messaging application is currently used by the user. A pushpin-shaped fixed control may be located/provided in a top of each interface of the instant messaging application. The preset operation is to click the fixed control.

In some embodiments, the user chats with a friend on a chat interface A, and at this time, the friend sends a link kb1 to an official account article on the chat interface. At this time, the user not only wants to keep an eye on a change of the chat interface A, but also wants to jump to an interface B pointed to by the link kb1 to the official account article, and the user may click a pushpin-shaped control g1 on a top of the chat interface A. Then the user may further click the link kb1 to the official account article to trigger the interface jump. In this way, the display screen may be triggered to display the first area Q1 and the second area Q2, the chat interface A is displayed in the first area Q1, and the interface B corresponding to the official account article is displayed in the second area Q2. The chat interface A displayed in the first area Q1 is a scaled-down chat interface A, and the chat interface D displayed in the first area Q1 is a keep-alive interface.

In some embodiments, the user is further interested in a content of another jump link kb2 on the interface B, and at the same time, the user also wants to continue reading the official account article on the interface B in the future. Then, the user may click a pushpin-shaped control g2 on a top of the interface B, and further click a jump link kb2 on the interface B, such that a scaled-down and keep-alive interface B may be triggered to be displayed in the first area Q1. At this time, the scaled-down interface A and the scaled-down interface B are displayed in the first area Q1, and an interface D corresponding to another jump link is displayed in the second area Q2.

Then, in an embodiment, the user finds that a friend further sends another chat message through the chat interface A displayed in the first area Q1. In addition, the user wants to continue to view the interface D in the future, the user may click a fixed control g3 on the interface D, and then may click the chat interface A displayed in the first area Q1, such that the interface D displayed in the second area Q2 is replaced by the chat interface A. At this time, the scaled-down interfaces B and the scaled-down D may be displayed in the first area Q1.

In another embodiment, the user finds that a friend further sends another chat message through the chat interface A displayed in the first area Q1, and the user does not want to continue to view the interface D, and then the user may click the chat interface A displayed in the first area Q1, such that the interface D displayed in the second area Q2 is replaced by the chat interface A. At this time, the scaled-down interface B may be displayed in the first area Q1, and interface D is directly covered/overwritten.

It may be seen that in the embodiments, the user may display a certain interface in a keep-alive manner in the first area through the preset operation and the interface jump operation, and an interface displayed in an alive manner in the first area may be quickly switched to the second area for viewing when necessary. In this way, it may be possible to efficiently realize multi-task collaboration and greatly improve an ability to quickly reach an interface corresponding to a task, and thus the user experience and the interaction playability may be improved at the same time.

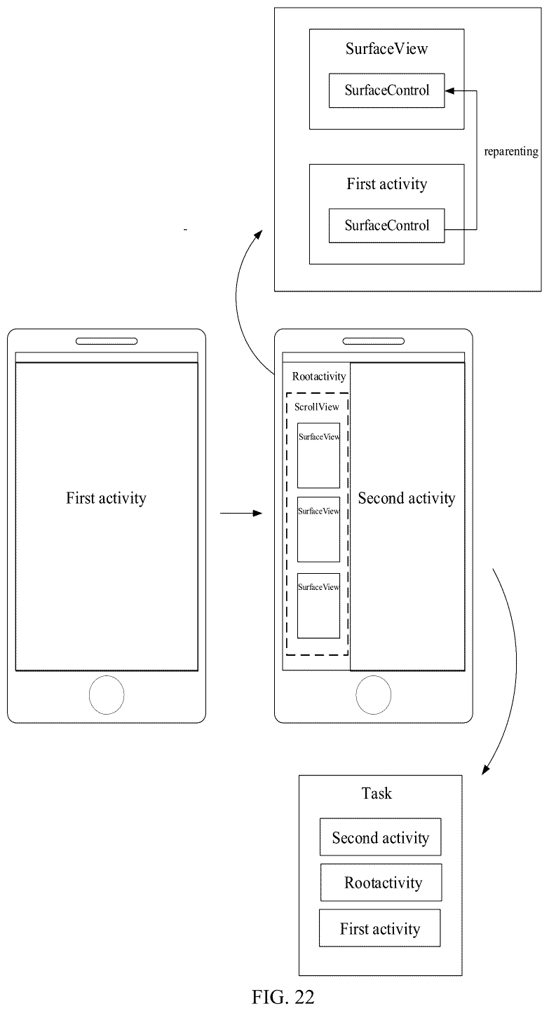

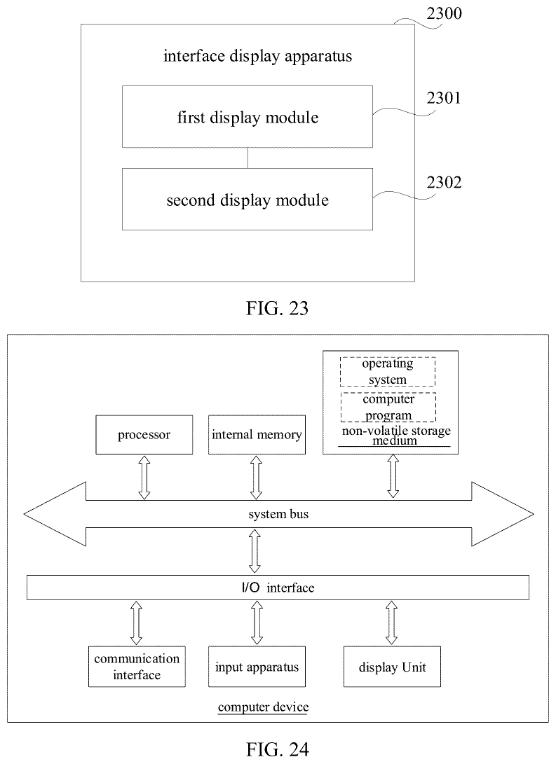

In the following, a case that the first area and the second area are displayed after receiving the jump instruction that is configured to jump from the first interface to the second interface may be taken as an example to describe a technical implementation method provided in the embodiments of the present disclosure. As shown in FIG. 22 and FIG. 23, the technical implementation process includes the following operations.

In an operation 2101, after an interface jump operation that is configured to jump from the first interface to the second interface is detected, a Rootactivity component corresponding to the first area and a second activity component corresponding to the second interface are created in a task of a first activity component corresponding to the first interface.

The second activity component is disposed at a top of the task, and the Rootactivity component is located behind the second activity component in the task. The Rootactivity component includes a ScrollView control, and a plurality of Surface View areas are defined in the ScrollView control.

In addition, a bounds value of the second activity component is set to specify a position where the new first activity component is displayed in the display screen, and in some embodiments, the display position may be a right area of the display screen. In addition, a bounds value of the RootActivity component is set to specify a position where the RootActivity component is displayed in the display screen, and in some embodiments, the display position may be a left area of the display screen.

An activity component is one of the basic and common four components in an Android system. The activity component may provide an interface with which the user may interact to accomplish a certain task. A Task (also known as a Task sack) is a container with a stack structure, which may arrange a plurality of activity examples. Generally, an activity example disposed at the top of the task is displayed on the display screen of the electronic device. A ScrollView control is a basic UI control in the Android system, and a Chinese translation of the ScrollView control may be a scroll bar or a vertical scroll bar. A Surface View is a buffer area of the display screen in which a graphic may be drawn.

In an operation 2102, the first activity component, a Rootactivity component, and the Rootactivity component are set to be a visible state and a resumed state.

In the Android system, the activity component has a plurality of states. The visible state and the resumed state are states of the activity component, i.e., an active state that is visible and where it is interacted with the user.

In an operation 2103, a SurfaceControl of the first activity component is reparented to a first Surface View area of the plurality of Surface View areas, a scaling/zooming operation is performed on the SurfaceControl of the first activity component according to a size of the first Surface View area, and a display position of the SurfaceControl of the first activity component is updated according to a position of the first Surface View area.

In this way, a display content of the first activity component may be carried by the first Surface View. The display position of the SurfaceControl of the first activity component is updated through a setposition. A scaling factor of the SurfaceControl of the first activity component is updated through a setmatrix.

In a condition where a plurality of activity assemblies are carried by a plurality of Surface Views in the ScrollView, that is, in a condition where there are a plurality of interfaces in the first area, the plurality of activity assemblies may be browsed by sliding the ScrollView.

In a condition where the second target interface displayed in the second area is replaced by the first target interface, a third activity component corresponding to the first target interface may be disposed at the top of the task, and an association, between the third activity component and a second Surface View area in the ScrollView control included in the Rootactivity component corresponding to the first area, may be disconnected. In a condition where the second target interface needs to be displayed in the first area, the SurfaceControl of the fourth activity component corresponding to the second target interface may be reparented to the third Surface View area in the plurality of Surface View areas, the scaling operation is performed on the SurfaceControl of a fourth activity component according to a size of the third Surface View area, and the display position of the SurfaceControl of the fourth activity component is updated according to a position of the third Surface View area.

When the size of the first area and the size of the second area are adjusted in response to the size adjusting operation, the bounds value of the Rootactivity component corresponding to the first area and the bounds value of the fourth activity component corresponding to the second target interface displayed in the second area may be adjusted according to the size adjusting operation. Further, a scaling factor, which is corresponding to the activity component of the Surface View area in the ScrollView control included in the Rootactivity component, may also be adjusted.

In some embodiments, there is no duplicate interface in the first area and the second area, that is, a same interface (a same activity) is not displayed in the first area and the second area at the same time, and two same interfaces (two same activities) are not displayed in the first area.

Based on a same concept of the present disclosure, an interface display apparatus for implementing the above-mentioned interface display method may further be provided by the embodiments of the present disclosure. A technical solution to solve the problem and provided by the apparatus is similar to the technical solution described in the above-mentioned interface display method, and therefore a specific definition of one or more interface display apparatuses provided by the embodiments as follows may refer to the above-mentioned definition of the interface display method, which will not be repeated herein.

In an embodiment, as shown in FIG. 23, an interface display apparatus 2300 is provided by the embodiments of the present disclosure. The interface display apparatus 2300 includes a first display module 2301 and a second display module 2302.

The first display module 2301 is configured to display a first interface of an application on a display screen.

During the process of displaying the first interface, the second display module 2301 is configured to display a first area and a second area, display the first interface in the first area, and display a second interface of the application jumped from the first interface in the second area, in response to detecting a preset operation and detecting an interface jump operation for the first interface. Both of the first area and the second area are configured to display an interface of the application.

In some embodiments of the present disclosure, at least one interface is displayed in the first area, and the second display module 2302 is further configured to replace a second target interface displayed in the second area with the first target interface, in response to detecting a triggering operation for a first target interface displayed in the first area.

In some embodiments of the present disclosure, the second display module 2302 is further configured to display the second target interface in the first area.

In some embodiments of the present disclosure, the second display module 2302 is further configured to display, in a condition of the second target interface displayed in the second area being replaced by the first target interface, the second target interface, before detecting a triggering operation for the first target interface displayed in the first area and in response to detecting the preset operation for the second target interface displayed in the second area.

In some embodiments of the present disclosure, the first target interface is the first interface, and the second target interface is the second interface.

In some embodiments of the present disclosure, the second display module 2302 is further configured to display the second target interface in the first area, and display the third interface in the second area, in response to detecting the preset operation for the second target interface displayed in the second area and detecting an interface jump operation that is configured to jump from the second interface to a third interface of the application.

In some embodiments of the present disclosure, the second display module 2302 is further configured to adjust, based on a size adjusting operation, at least one of a size of the first area and a size of the second area, in response to detecting the size adjusting operation for the first interface.

In some embodiments of the present disclosure, in response to detecting a browsing operation for the first area the second display module 2302 is further configured to swipe, based on the detected browsing operation, the plurality of interfaces in the first area, in a condition of the first area having a plurality of interfaces therein.

In some embodiments of the present disclosure, the first area is superimposed on the second area and covers a part of the second area. Alternatively, there is no overlapping area between the first area and the second area.

In some embodiments of the present disclosure, in a condition of a size of the display screen of the electronic device being smaller than a preset size threshold, the second display module 2302 is further configured to display the first area and the second area in a displaying manner that the first area is superimposed on the second area and covers the part of the second area. In a condition of a size of the display screen of the electronic device being greater than or equal to a preset size threshold, the second display module 2302 is further configured to display the first area and the second area in a displaying manner that the first area and the second area are non-overlapping.

In some embodiments of the present disclosure, the first area and the second area are arranged horizontally. Alternatively, the first region and the second region may be arranged vertically.

In some embodiments of the present disclosure, the first area includes a drawer control, and the second display module 2302 is further configured to hide other parts in the first area except the drawer control in response to detecting a triggering operation for the drawer control, during the process of displaying the first area.

In some embodiments of the present disclosure, the second display module 2302 is further configured to place the second target interface in a hidden first area, and displaying the third interface in the second area, in response to detecting the preset operation for the second target interface displayed in the second area and detecting an interface jump operation that is configured to jump from the second interface to a third interface of the application.

In some embodiments of the present disclosure, the second display module 2302 is further configured to redisplay the first area in response to detecting the triggering operation for the drawer control.

In some embodiments of the present disclosure, the second display module 2302 is further configured to redisplay the first area and display the second target interface in the first area.

In some embodiments of the present disclosure, at least one of the first area and the second area includes a closing control, and the second display module 3202 is further configured to close, based on an area set by a triggered closing control, the first area or the second area, in response to detecting a triggering operation for the closing control.

In some embodiments of the present disclosure, at least one interface is displayed in the first area, the interface displayed in the first area includes a closing control, and the second display module 3202 is further configured to close the first target interface in the first area, in response to detecting a triggering operation for the closing control of the first target interface displayed in the first area.

In some embodiments of the present disclosure, the preset operation includes target gesture operation. Alternatively, the preset operation may include a triggering operation for a fixed control.

In some embodiments of the present disclosure, the preset operation includes the triggering operation for the fixed control. The second display module 2302 is further configured to display a first function description interface in response to the fixed control being displayed for the first time, where the first function description interface includes function description information of the fixed control.

Each of modules in the above-described interface display apparatus may be implemented in whole or in part by software, hardware, and a combination thereof. The above-described modules may be embedded in or independent of a processor of the electronic device in a hardware form, or may be stored in a memory of the electronic device in a software form, such that the processor may call and perform operations corresponding to the above-described modules.

In an embodiment, an electronic device is provided by the embodiments of the present disclosure, and an internal structure of the electronic device may be illustrated in FIG. 24. The electronic device includes a processor, a memory, a communication interface, a display screen, and an input apparatus connected through a system bus. The processor of the electronic device is configured to provide computing and control capabilities. The memory of the electronic device includes a non-volatile storage medium and an internal memory. The non-volatile storage medium stores an operating system and a computer program. The internal memory is configured to provide a running environment for the operating system and the computer program in the non-volatile storage medium. The communication interface of the electronic device is configured to communicate with an external electronic device in a wired or wireless manner. The wireless manner may be implemented through WIFI, mobile cellular internetwork, near field communication (NFC), or other technologies. The computer program is executed by the processor to perform an interface display method is realized. The display screen of the electronic device may a liquid crystal display screen or an electronic ink display screen. The input apparatus of the electronic device may be a touch layer covered on the display screen. Alternatively, the input apparatus of the electronic device may be a key, a trackball, or a touch panel arranged on a shell of the electronic device. Alternatively, the input apparatus of the electronic device may be an external keyboard, a touch panel, a mouse, etc.

It should be understood by those skilled in the art that a structure as shown in FIG. 24 is only a block diagram of a part of the structure related to the solution of the present disclosure, and does not constitute a limitation to the electronic device to which the solution of the present disclosure is applied. The electronic device may include more or fewer components than those as shown in the drawings, some combined components, or have different component arrangements.

In an embodiment, an electronic device is provided by the embodiments of the present disclosure. The electronic device includes a memory and a processor, a computer program is stored in the memory, and the computer program is executed by the processor to perform the following operations.

The computer program is configured to be executed by the processor to perform: displaying a first interface of an application on the display screen; and displaying a first area and a second area, displaying the first interface in the first area, and displaying a second interface of the application jumped from the first interface in the second area, in response to detecting a preset operation and detecting an interface jump operation for the first interface, during the process of displaying the first interface. Both of the first area and the second area are configured to display an interface of the application.

In an embodiment, at least one interface is displayed in the first area, and the computer program is configured to be executed by the processor to perform: replacing a second target interface displayed in the second area with the first target interface, in response to detecting a triggering operation for a first target interface displayed in the first area.

In an embodiment, the computer program is configured to be executed by the processor to perform: displaying the second target interface in the first area.

In an embodiment, the computer program is configured to be executed by the processor to perform: in a condition of the second target interface displayed in the second area being replaced by the first target interface, displaying the second target interface in the first area, before detecting a triggering operation for the first target interface displayed in the first area and in response to detecting the preset operation for the second target interface displayed in the second area.

In an embodiment, the first target interface is the first interface, and the second target interface is the second interface.

In an embodiment, the computer program is configured to be executed by the processor to perform displaying the second target interface in the first area, and displaying the third interface in the second area, in response to detecting the preset operation for the second target interface displayed in the second area and detecting an interface jump operation that is configured to jump from the second interface to a third interface of the application.

In an embodiment, the computer program is configured to be executed by the processor to perform: adjusting, based on a size adjusting operation, at least one of a size of the first area and a size of the second area, in response to detecting the size adjusting operation for the first interface.

In an embodiment, the computer program is configured to be executed by the processor to perform: in response to detecting a browsing operation for the first area, swiping, based on the detected browsing operation, the plurality of interfaces in the first area, in a condition of the first area having a plurality of interfaces therein.

In an embodiment, the first area is overlaid and displayed on top of the second area, covering a part of the second area. Alternatively, there is no overlapping area between the first region and the second region.

In an embodiment, the computer program is further configured to be executed by the processor to perform: displaying, in a displaying manner that the first area is superimposed on the second area and covers the part of the second area, the first area and the second area in a condition of a size of the display screen of the electronic device being smaller than a preset size threshold. The computer program is further configured to be executed by the processor to perform: displaying, in a displaying manner that the first area and the second area are non-overlapping, the first area and the second area in a condition of a size of the display screen of the electronic device being greater than a preset size threshold.

In an embodiment, the first area and the second area are horizontally arranged. Alternatively, the first area and the second area may be arranged longitudinally.

In an embodiment, the first area includes a drawer control. The computer program is further configured to be executed by the processor to perform: hiding other parts in the first area except the drawer control in response to detecting a triggering operation for the drawer control, during the process of displaying the first area.

In an embodiment, the computer program is further configured to be executed by the processor to perform: placing the second target interface in a hidden first area, and displaying the third interface in the second area, in response to detecting the preset operation for the second target interface displayed in the second area and detecting an interface jump operation that is configured to jump from the second interface to a third interface of the application.

In an embodiment, the computer program is further configured to be executed by the processor to perform: redisplaying the first area in response to detecting the triggering operation for the drawer control.

In an embodiment, the computer program is further configured to be executed by the processor to perform: redisplaying the first area and displaying the second target interface in the first area.

In an embodiment, at least one of the first area and the second area includes a closing control. The computer program is further configured to be executed by the processor to perform: closing, based on an area set by a triggered closing control, the first area or the second area, in response to detecting a triggering operation for the closing control.

In an embodiment, at least one interface is displayed in the first area. The interface displayed in the first area includes a closing control. The computer program is further configured to be executed by the processor to perform: closing the first target interface in the first area, in response to detecting a triggering operation for the closing control of the first target interface displayed in the first area.

In an embodiment, the preset operation includes a target gesture operation. Alternatively, the preset operation includes a triggering operation for a fixed control.

In an embodiment, the preset operation includes the triggering operation for the fixed control. The computer program is further configured to be executed by the processor to perform: displaying a first function description interface in response to the fixed control being displayed for the first time, where the first function description interface includes function description information of the fixed control.

In an embodiment, a computer-readable storage medium is provided by the embodiments of the present disclosure, and a computer program is stored on computer-readable storage medium. The computer program is executed by a processor to perform the following operations.

The computer program is configured to be executed by the processor to perform: displaying a first interface of an application on the display screen; and displaying a first area and a second area, displaying the first interface in the first area, and displaying a second interface of the application jumped from the first interface in the second area, in response to detecting a preset operation and detecting an interface jump operation for the first interface, during the process of displaying the first interface. Both of the first area and the second area are configured to display an interface of the application.

In an embodiment, at least one interface is displayed in the first area, and the computer program is configured to be executed by the processor to perform: replacing a second target interface displayed in the second area with the first target interface, in response to detecting a triggering operation for a first target interface displayed in the first area.

In an embodiment, the computer program is configured to be executed by the processor to perform: displaying the second target interface in the first area.

In an embodiment, the computer program is configured to be executed by the processor to perform: in a condition of the second target interface displayed in the second area being replaced by the first target interface, displaying the second target interface in the first area, before detecting a triggering operation for the first target interface displayed in the first area and in response to detecting the preset operation for the second target interface displayed in the second area.

In an embodiment, the first target interface is the first interface, and the second target interface is the second interface.

In an embodiment, the computer program is configured to be executed by the processor to perform displaying the second target interface in the first area, and displaying the third interface in the second area, in response to detecting the preset operation for the second target interface displayed in the second area and detecting an interface jump operation that is configured to jump from the second interface to a third interface of the application.

In an embodiment, the computer program is configured to be executed by the processor to perform: adjusting, based on a size adjusting operation, at least one of a size of the first area and a size of the second area, in response to detecting the size adjusting operation for the first interface.

In an embodiment, the computer program is configured to be executed by the processor to perform: in response to detecting a browsing operation for the first area, swiping, based on the detected browsing operation, the plurality of interfaces in the first area, in a condition of the first area having a plurality of interfaces therein.

In an embodiment, the first area is overlaid and displayed on top of the second area, covering a part of the second area. Alternatively, there is no overlapping area between the first region and the second region.

In an embodiment, the computer program is further configured to be executed by the processor to perform: displaying, in a displaying manner that the first area is superimposed on the second area and covers the part of the second area, the first area and the second area in a condition of a size of the display screen of the electronic device being smaller than a preset size threshold. The computer program is further configured to be executed by the processor to perform: displaying, in a displaying manner that the first area and the second area are non-overlapping, the first area and the second area in a condition of a size of the display screen of the electronic device being greater than a preset size threshold.

In an embodiment, the first area and the second area are horizontally arranged. Alternatively, the first area and the second area may be arranged longitudinally.

In an embodiment, the first area includes a drawer control. The computer program is further configured to be executed by the processor to perform: hiding other parts in the first area except the drawer control in response to detecting a triggering operation for the drawer control, during the process of displaying the first area.

In an embodiment, the computer program is further configured to be executed by the processor to perform: placing the second target interface in a hidden first area, and displaying the third interface in the second area, in response to detecting the preset operation for the second target interface displayed in the second area and detecting an interface jump operation that is configured to jump from the second interface to a third interface of the application.

In an embodiment, the computer program is further configured to be executed by the processor to perform: redisplaying the first area in response to detecting the triggering operation for the drawer control.

In an embodiment, the computer program is further configured to be executed by the processor to perform: redisplaying the first area and displaying the second target interface in the first area.

In an embodiment, at least one of the first area and the second area includes a closing control. The computer program is further configured to be executed by the processor to perform: closing, based on an area set by a triggered closing control, the first area or the second area, in response to detecting a triggering operation for the closing control.

In an embodiment, at least one interface is displayed in the first area. The interface displayed in the first area includes a closing control. The computer program is further configured to be executed by the processor to perform: closing the first target interface in the first area, in response to detecting a triggering operation for the closing control of the first target interface displayed in the first area.

In an embodiment, the preset operation includes a target gesture operation. Alternatively, the preset operation includes a triggering operation for a fixed control.

In an embodiment, the preset operation includes the triggering operation for the fixed control. The computer program is further configured to be executed by the processor to perform: displaying a first function description interface in response to the fixed control being displayed for the first time, where the first function description interface includes function description information of the fixed control.

In an embodiment, a computer program product is provided by the embodiments of the present disclosure. The computer program product includes a computer program, and the computer program is executed by the processor to perform the following operations.

The computer program is configured to be executed by the processor to perform: displaying a first interface of an application on the display screen; and displaying a first area and a second area, displaying the first interface in the first area, and displaying a second interface of the application jumped from the first interface in the second area, in response to detecting a preset operation and detecting an interface jump operation for the first interface, during the process of displaying the first interface. Both of the first area and the second area are configured to display an interface of the application.

In an embodiment, at least one interface is displayed in the first area, and the computer program is configured to be executed by the processor to perform: replacing a second target interface displayed in the second area with the first target interface, in response to detecting a triggering operation for a first target interface displayed in the first area.

In an embodiment, the computer program is configured to be executed by the processor to perform: displaying the second target interface in the first area.

In an embodiment, the computer program is configured to be executed by the processor to perform: in a condition of the second target interface displayed in the second area being replaced by the first target interface, displaying the second target interface in the first area, before detecting a triggering operation for the first target interface displayed in the first area and in response to detecting the preset operation for the second target interface displayed in the second area.

In an embodiment, the first target interface is the first interface, and the second target interface is the second interface.

In an embodiment, the computer program is configured to be executed by the processor to perform displaying the second target interface in the first area, and displaying the third interface in the second area, in response to detecting the preset operation for the second target interface displayed in the second area and detecting an interface jump operation that is configured to jump from the second interface to a third interface of the application.

In an embodiment, the computer program is configured to be executed by the processor to perform: adjusting, based on a size adjusting operation, at least one of a size of the first area and a size of the second area, in response to detecting the size adjusting operation for the first interface.

In an embodiment, the computer program is configured to be executed by the processor to perform: in response to detecting a browsing operation for the first area, swiping, based on the detected browsing operation, the plurality of interfaces in the first area, in a condition of the first area having a plurality of interfaces therein.

In an embodiment, the first area is overlaid and displayed on top of the second area, covering a part of the second area. Alternatively, there is no overlapping area between the first region and the second region.

In an embodiment, the computer program is further configured to be executed by the processor to perform: displaying, in a displaying manner that the first area is superimposed on the second area and covers the part of the second area, the first area and the second area in a condition of a size of the display screen of the electronic device being smaller than a preset size threshold. The computer program is further configured to be executed by the processor to perform: displaying, in a displaying manner that the first area and the second area are non-overlapping, the first area and the second area in a condition of a size of the display screen of the electronic device being greater than a preset size threshold.

In an embodiment, the first area and the second area are horizontally arranged. Alternatively, the first area and the second area may be arranged longitudinally.

In an embodiment, the first area includes a drawer control. The computer program is further configured to be executed by the processor to perform: hiding other parts in the first area except the drawer control in response to detecting a triggering operation for the drawer control, during the process of displaying the first area.

In an embodiment, the computer program is further configured to be executed by the processor to perform: placing the second target interface in a hidden first area, and displaying the third interface in the second area, in response to detecting the preset operation for the second target interface displayed in the second area and detecting an interface jump operation that is configured to jump from the second interface to a third interface of the application.

In an embodiment, the computer program is further configured to be executed by the processor to perform: redisplaying the first area in response to detecting the triggering operation for the drawer control.

In an embodiment, the computer program is further configured to be executed by the processor to perform: redisplaying the first area and displaying the second target interface in the first area.

In an embodiment, at least one of the first area and the second area includes a closing control. The computer program is further configured to be executed by the processor to perform: closing, based on an area set by a triggered closing control, the first area or the second area, in response to detecting a triggering operation for the closing control.

In an embodiment, at least one interface is displayed in the first area. The interface displayed in the first area includes a closing control. The computer program is further configured to be executed by the processor to perform: closing the first target interface in the first area, in response to detecting a triggering operation for the closing control of the first target interface displayed in the first area.

In an embodiment, the preset operation includes a target gesture operation. Alternatively, the preset operation includes a triggering operation for a fixed control.

In an embodiment, the preset operation includes the triggering operation for the fixed control. The computer program is further configured to be executed by the processor to perform: displaying a first function description interface in response to the fixed control being displayed for the first time, where the first function description interface includes function description information of the fixed control.

It should be noted that user information (including, but not limited to, user device information, user personal information, etc.) and data (including, but not limited to, data configured for analysis, stored data, displayed data, etc.) involved in the present disclosure are all information and data authorized by the user or fully authorized by all parties.

Those skilled in the art may understand that all or part of the process of implementing the above embodiments of the present disclosure may be completed by a computer program to instruct related hardware, and the program may be stored in a non-volatile computer readable storage medium. The program, when executed, may include the flow of the methods of the embodiments as described above. Any reference to a memory, a database, or other media provided in the embodiments of the present disclosure may include at least one of a non-volatile memory and a volatile memory. The non-volatile memory may include a read-only memory (ROM), a tape, a floppy disk, a flash memory, an optical memory, a high-density embedded non-volatile memory, a resistive random access memory (RcRAM), a magnetoresistive RAM (MRAM), a ferroelectric RAM (FRAM), a phase change memory (PCM), a graphene memory, etc. The volatile memory may include a RAM or an external cache memory. For illustration and not limitation, the RAM is available in various forms, such as a static RAM (SRAM), a dynamic RAM (DRAM), etc. The database provided in the embodiments of the present disclosure may include at least one of a relational database and a non-relational database. The non-relational database may include a blockchain-based distributed database, etc., which is not limited herein. The processor provided in the embodiments of the present disclosure may be a general processor, a central processor, a graphics processor, a digital signal processor, a programmable logic controller, a quantum computing-based data processing logic controller, etc., which is not limited herein.

Technical features of the above-mentioned embodiments could be combined arbitrarily. In order to make the description concise, not all possible combinations of the various technical features in the above-mentioned embodiments are described. However, as long as there is no contradiction in the combination of these technical features, all combinations should be considered to be within the scope of the specification.

The above-mentioned embodiments only express a few implementations of the present disclosure, the description thereof is relatively specific and detailed, but they could not be construed as a limitation on the scope of the patent application. It should be pointed out that, for those of ordinary skills in the art, without departing from the concept of this application, several modifications and improvements could be made, and these all fall within the protection scope of the present disclosure. Therefore, the protection scope of this patent application should be subject to the appended claims.

What is claimed:

1. An interface display method, applicable to an electronic device, the electronic device comprising a display screen, and the method comprising:
displaying a first interface of an application on the display screen; and
displaying a first area and a second area, displaying the first interface in the first area, and displaying a second interface of the application jumped from the first interface in the second area, in response to detecting a preset operation and detecting an interface jump operation for the first interface, during the process of displaying the first interface, wherein both of the first area and the second area are configured to display an interface of the application.

2. The method according to claim 1, wherein at least one interface is displayed in the first area, and the method further comprises:
replacing a second target interface displayed in the second area with the first target interface in response to detecting a triggering operation for a first target interface displayed in the first area.

3. The method according to claim 2, further comprising:
displaying the second target interface in the first area.

4. The method according to claim 3, wherein displaying the second target interface in the first area, comprises:
in a condition of the second target interface displayed in the second area being replaced by the first target interface, displaying the second target interface in the first area, before detecting a triggering operation for the first target interface displayed in the first area and in response to detecting the preset operation for the second target interface displayed in the second area.

5. The method according to claim 2, wherein the first target interface is the first interface, and the second target interface is the second interface.

6. The method according to claim 1, further comprising:
displaying the second target interface in the first area, and displaying the third interface in the second area, in response to detecting the preset operation for the second target interface displayed in the second area and detecting an interface jump operation that is configured to jump from the second interface to a third interface of the application; or
adjusting, based on a size adjusting operation, at least one of a size of the first area and a size of the second area in response to detecting the size adjusting operation for the first interface.

7. The method according to claim 1, further comprising:
in response to detecting a browsing operation for the first area, swiping, based on the detected browsing operation, the plurality of interfaces in the first area, in a condition of the first area having a plurality of interfaces therein.

8. The method according to claim 1, wherein the first area is superimposed on the second area and covers a part of the second area; or
there is no overlapping area between the first area and the second area.

9. The method according to claim 8, further comprising:
in a condition of a size of the display screen of the electronic device being smaller than a preset size threshold, displaying, in a displaying manner that the first area is superimposed on the second area and covers the part of the second area, the first area and the second area;
in a condition of the size of the display screen of the electronic device being greater than or equal to the preset size threshold, displaying, in a displaying manner that the first area and the second area are non-overlapping, the first area and the second area.

10. The method according to claim 1, wherein the first area and the second area are horizontally arranged; or
the first area and the second area are arranged longitudinally.

11. The method according to claim 1, wherein the first area comprises a drawer control, and the method further comprises:
hiding other parts in the first area except the drawer control in response to detecting a triggering operation for the drawer control, during the process of displaying the first area.

12. The method according to claim 11, further comprising:
placing the second target interface in a hidden first area, and displaying the third interface in the second area, in response to detecting the preset operation for the second target interface displayed in the second area and detecting an interface jump operation that is configured to jump from the second interface to a third interface of the application.

13. The method according to claim 1, wherein after hiding the other parts of the first area except the drawer control, the method further comprises:
redisplaying the first area in response to detecting the triggering operation for the drawer control.

14. The method according to claim 1, wherein redisplaying the first area, comprises:
redisplaying the first area and displaying the second target interface in the first area.

15. The method according to claim 1, wherein at least one of the first area and the second area comprises a closing control, and the method further comprises:
closing, based on an area set by a triggered closing control, the first area or the second area in response to detecting a triggering operation for the closing control; or
wherein at least one interface is displayed in the first area, an interface displayed in the first area comprises a closing control, and the method further comprises:
closing the first target interface in the first area in response to detecting a triggering operation for the closing control of the first target interface displayed in the first area.

16. The method according to claim 1, wherein the preset operation comprises a target gesture operation; or
the preset operation comprises a triggering operation for a fixed control.

17. The method according to claim 16, wherein the preset operation comprises the triggering operation for the fixed control, and the method further comprises:
displaying a first function description interface in response to the fixed control being displayed for the first time, wherein the first function description interface comprises function description information of the fixed control.

18. An electronic device, comprising a memory and a processor, wherein the memory stores a computer program, and the computer program is configured to be executed by the processor to perform:
displaying a first interface of an application on the display screen; and
displaying a first area and a second area, displaying the first interface in the first area, and displaying a second interface of the application jumped from the first interface in the second area, in response to detecting a preset operation and detecting an interface jump operation for the first interface, during the process of displaying the first interface, wherein both of the first area and the second area are configured to display an interface of the application.

19. The electronic device according to claim 18, wherein at least one interface is displayed in the first area, and the computer program is further configured to be executed by the processor to perform:
replacing a second target interface displayed in the second area with the first target interface in response to detecting a triggering operation for a first target interface displayed in the first area.

20. A computer-readable storage medium, on which a computer program is stored, wherein the computer program is configured to be executed by the processor to perform:
displaying a first interface of an application on the display screen; and
displaying a first area and a second area, displaying the first interface in the first area, and displaying a second interface of the application jumped from the first interface in the second area, in response to detecting a preset operation and detecting an interface jump operation for the first interface, during the process of displaying the first interface, wherein both of the first area and the second area are configured to display an interface of the application.
